(19) United States
(12) Patent Application Publication
(10) Pub. No.: US 2026/0198528 A1
(43) Pub. Date: Jul. 16, 2026

(54) NITROGEN-DOPED ISOACIDS AS A NUTRITIONAL SUPPLEMENT FOR LIVESTOCK AND POULTRY

(71) Applicant: Zinpro Corporation, Eden Prairie, MN (US)

(72) Inventors: Peter A. Stark, Inver Grove Heights, MN (US); Michael Thomas Socha, Rogers, MN (US); Ambo Ayele Bati, Savage, MN (US)

(21) Appl. No.: 19/025,074

(22) Filed: Jan. 16, 2025

(51) Int. Cl. A23K 20/105; A23K 20/20; A23K 50/10; A23K 50/30; A23K 50/75

(52) U.S. Cl. CPC A23K 20/105; A23K 20/20; A23K 50/10; A23K 50/30; A23K 50/75

(57) ABSTRACT

This disclosure describes nutritional supplement compositions for animal consumption, nutritionally supplemented animal feed compositions, and methods of preparing each. The supplements and feed are particularly suitable for ruminants, swine, and poultry. Beneficially, the nutritional supplements and nutritionally supplemented feed include a mixture of isoacids and a nitrogen source; the nitrogen source comprises a combination of urea and ammonium hydroxide. Beneficially, the compositions and methods of preparation reduce the potency of pervasive odor characteristics of the isoacids. The compositions and methods and systems relate to combining isoacids with an animal feed, including, liquid feeds, blended solid animal feeds, or total mixed rations (TMR).

### TECHNICAL FIELD

This disclosure relates generally to nutritional supplements useful for supplying nutrients to ruminants, swine, and poultry. The nutritional supplements reduce the potency of pervasive odors stemming from the isoacids and beneficially add a nitrogen source for the rumen and gut bacteria. The disclosure further discusses nutritionally supplemented animal feed and methods of preparing the nutritional supplements and nutritionally supplemented animal feed.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Volatile fatty acids such as butyric acid, isobutyric acid, 2-methylbutyric acid, isovaleric acid, and valeric acid are known feed supplements for ruminants, swine, and poultry. For instance, when used as a feed supplement for dairy cattle, milk production is increased. Additionally, these fatty acids have a role as specific nutrients for the ruminal cellulolytic bacteria that act to degrade fibrous feed material during digestion. Further, the fatty acids seem to have a general positive influence on microbial fermentation. However, these volatile acids have a strong odor. The odor is a significant problem to the human workers producing, handling, and/or distributing the acids. Such problems can include nausea and vomiting due to the strong odor.

Previous efforts to reduce the odor include U.S. Pat. No. 4,376,790, which relates to decreasing odor by making ammonium and calcium salts of fatty acids. Additionally, U.S. Pat. No. 10,034,843 relates to overcoming the odor problem by producing feed supplements that are odor free by reacting a pendant carboxylic acid on a water soluble polycarboxylic acid, a polyvalent metal salt, and the odorous volatile fatty acid. The polyvalent metal ion is bonded to the pendant carboxylic acid group of the polycarboxylic acid and the carboxylic acid group of the fatty acid. Another approach has been to putrid odor problems of low molecular weight volatile fatty acids as nutritional supplements for livestock and poultry by reacting a calcium ion source with low molecular weight volatile fatty acid in a solid phase neat reaction, and then using the reaction product as a nutritional supplement. These known solutions require processing of the fatty acids which adds to the cost and time of making and distributing the feed supplements.

Another process has been to secure the isoacids in sealed containers and sealed liquid feed systems such that the pervasive odors are contained and prevented from exposure to humans. While such a process is useful for preventing exposure to the odors it is not suitable for all livestock feed operations and preferences. For example, some livestock feed operations may not have liquid feed systems nor the infrastructure to convert to a liquid feed system. Further, other livestock feed operations may prefer to provide livestock feed via solid feed or mixed rations.

Accordingly, there is a continued need for convenient low-cost methods to lower the odor so as to make volatile fatty acid derived fermentation enhancers a viable feed supplement product.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

A preferred embodiment described herein is a nutritional feed supplement composition for livestock and poultry comprising: from about 30 wt. % to about 70 wt. % of one or more isoacids comprising isobutyric acid, butyric acid, 2-methylbutyric acid, 3-methylbutyric acid (isovaleric acid), valeric acid and salts thereof; and from about 30 wt. % to about 70 wt. % of a nitrogen source; wherein the nitrogen source comprises urea and ammonium hydroxide.

Another preferred embodiment described herein is a nutritionally supplemented animal feed composition comprising: an animal feed comprising a grain, an oilseed, an oilseed meal, a forage byproduct, forages, an oilseed byproduct, an animal-derived product, a vegetable, a nut, a seed, a fruit, a tuber, molasses, a vegetable oil, a seed oil, an animal fat, a milk, whey, a polysaccharide, a protein concentrate, a vitamin, a mineral, a fiber, or a mixture thereof; and an isoacid nutritional supplement comprising a one or more isoacids comprising isobutyric acid, butyric acid, 2-methylbutyric acid, 3-methylbutyric acid (isovaleric acid), valeric acid, and salts thereof; a nitrogen source; wherein the nitrogen source comprises urea and ammonium hydroxide; wherein the isoacid nutritional supplement comprises from about 30 wt. % to about 70 wt. % of the one or more isoacids and from about 30 wt. % to about 70 wt. % of the nitrogen source.

A further preferred embodiment described herein is a method of preparing a nutritional feed supplement composition having an acceptable odor for a human handler comprising: combining from about 30 wt. % to about 70 wt. % of one or more isoacids comprising isobutyric acid, butyric acid, 2-methylbutyric acid, 3-methylbutyric acid (isovaleric acid), valeric acid, and salts thereof; and from about 30 wt. % to about 70 wt. % of a nitrogen source; wherein the nitrogen source comprises urea and ammonium hydroxide.

A further preferred embodiment described herein is a method of preparing a nutritionally supplemented animal feed composition having an acceptable odor for a human handler comprising: combining an animal feed and an isoacid nutritional supplement to form the nutritionally supplemented animal feed composition; wherein the animal feed comprises a grain, an oilseed, an oilseed meal, a forage byproduct, forages, an oilseed byproduct, an animal-derived product, a vegetable, a nut, a seed, a fruit, a tuber, molasses, a vegetable oil, a seed oil, an animal fat, a milk, whey, a polysaccharide, a protein concentrate, a vitamin, a mineral, a fiber, or a mixture thereof; wherein an isoacid nutritional supplement comprising one or more isoacids comprising isobutyric acid, butyric acid, 2-methylbutyric acid, 3-methylbutyric acid (isovaleric acid), valeric acid, and salts thereof; a nitrogen source; wherein the nitrogen source comprises urea and ammonium hydroxide; and wherein the isoacid nutritional supplement comprises from about 30 wt. % to about 70 wt. % of the mixture of two or more isoacids and from about 30 wt. % to about 70 wt. % of the nitrogen source.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE FIGURES

FIG. 1 is a graph of odor preference comparing the acceptability of the nutritional supplement odor based on varying ratios of urea and ammonium hydroxide with isobutyric acid.

FIG. 2 is a graph of odor preference comparing the acceptability of the nutritional supplement odor based on varying ratios of urea and ammonium hydroxide with different isoacids and mixtures of isoacids.

The figures are provided for exemplary purposes and do not include all ratios, compositions, or ingredients that may be utilized in nutritional supplements or nutritionally supplemented animal feed as disclosed herein. An artisan of ordinary skill in the art need not view, within isolated figure, the near infinite number of distinct permutations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

The present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numerical values within that range, for example, 1, 2, 3, 4, 5, and 6, and decimals and fractions, for example, 1.2, 3.8, 1½, and 4¾ This applies regardless of the breadth of the range.

The term “about,” as used herein, refers to variations in size, distance or any other types of measurements that can be resulted from inherent heterogeneous nature of the measured objects and imprecise nature of the measurements itself, including, but not limited to, concentration, density, mass, molecular weight, odor, percentages, ratios, temperature, volume, and weight. The term “about” also encompasses variation in the numerical quantity that can occur, for example, through typical measuring or handling procedures in the real world; through inadvertent error in these procedures; through differences in the manufacture, source, or purity of the ingredients used to make the device or carry out the methods, and the like. Whether or not modified by the term “about”, the claims include equivalents to the quantities.

Terms characterizing sequential order, a position, and/or an orientation are not limiting and are only referenced according to the views presented.

The term “livestock” as used herein, includes, but is not limited to, ruminants and swine. Ruminants includes, but is not limited to, cattle, sheep, goats, water buffalo, antelopes, deer, giraffes, and their relatives.

The term “poultry” as used herein, includes, hens, chickens (including, but not limited to, broiler chicken), turkeys, and ducks.

The term, “supplemented feed” as used herein refers to a liquid feed, dry blended animal feed, and/or a TMR which has been supplemented with the isoacid.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

### Nutritional Feed Supplements for Livestock and Poultry

The disclosure herein is related to a compositions and methods for reducing the odor of volatile fatty acids, also known as isoacids, as a nutritional supplement for livestock. The disclosure is not limited by types of feed and rations which the nutritional supplements can be mixed with. Further, the ratio of nutritional supplement to feed vary significantly based on the type of livestock, age of livestock, purpose of livestock (e.g., dairy, meat, eggs), feed itself, and preference of the farmer or rancher. Accordingly, while there are descriptions of common or preferred ratios of nutritional supplements to livestock feed, there can be departures therefrom that would still benefit from the nutritional supplements disclosed herein.

The nutritional feed supplements comprise an isoacid and a nitrogen source; the nitrogen source comprises a mixture of urea and an ammonia group source (preferably provided via ammonium hydroxide). Preferably the isoacid is in a concentration of from about 30 wt. % to about 70 wt. % and the nitrogen source is in a concentration of from about 30 wt. % to about 70 wt. %.

A further embodiment is a nutritionally supplemented livestock feed composition comprising a livestock feed and a mixture of an isoacid and a nitrogen source, wherein the nitrogen source comprises urea and ammonium hydroxide.

### Isoacids

As used herein, an “isoacid” refers to the volatile fatty acids: isobutyric acid, butyric acid, 2-methylbutyric acid, 3-methylbutyric acid (isovaleric acid), valeric acid, any of their salts, and mixtures of the foregoing. In a preferred embodiment, the isoacid is isobutyric acid, butyric acid, 2-methylbutyric acid, 3-methylbutyric acid (isovaleric acid), valeric acid and salts thereof. In an embodiment, the isoacid is in the original acid form (referred to as “neat”), without processing into a salt and/or without additional pendant groups. Preferably the isoacid is not reacted (except as provided below when mixed with a nitrogen source) including specifically that it is unreacted to form an ester or an amide. In a preferred embodiment, the isoacid has not been otherwise processed into another compound to reduce the odor of the isoacid. The isoacid can be diluted with water or another liquid diluent; however, it is preferably without water or liquid diluent (there is water with the nitrogen source, which can in some embodiments provide sufficient dilution). It should be understood that the isoacid, once mixed with the nitrogen source and subsequently with other feed components (liquid or solid) can interact and form a salt and/or solid. Thus, while the isoacids are preferably free of pendant groups, it is possible that pendant ammonia groups can form with the isoacids (due to interaction with the nitrogen source) and most preferably the isoacids are free of other pendant groups.

The nutritional feed supplement preferably comprises from about 30 wt. % to about 70 wt. % of the isoacid (or mixture of isoacids); more preferably from about 35 wt. % to about 65 wt. % of the isoacid (or mixture of isoacids); most preferably from about 40 wt. % to about 60 wt. % of the isoacid (or mixture of isoacids).

### Nitrogen Source

The nutritional feed supplement includes a nitrogen source. The nitrogen source comprises both urea and an ammonia group source. The ammonia group is preferably provided in aqueous form. The aqueous form of ammonia is ammonium hydroxide solution. Ammonium hydroxide solutions can vary but often have between about 25 wt. % and about 30 wt. % of ammonia and about 70 wt. % to about 75 wt. % water (the water and ammonia form an equilibrium of ammonium hydroxide and ammonia). The urea can also be mixed with water which can be particularly helpful for dissolving the urea. Depending on the ratio of ammonium hydroxide to urea, the ammonium hydroxide can serve to dissolve the urea, and if needed a minor additional amount of water can be added.

The nitrogen source does not eliminate the pervasive odor of the isoacids; however, we have found that it masks the odor such that it prevents significant deleterious effects (e.g., vomiting, shortness of breath, passing out, and nausea). We have also found that independently neither urea nor ammonium hydroxide adequately masks the odor, but in combination they provide the unexpected benefit of masking the odor. The ratio of the urea to ammonium hydroxide can be a matter of preference, but via testing and evaluation we found that suitable ranges to prevent significant deleterious effects (e.g., vomiting, shortness of breath, passing out, and nausea) can include a very low amount of urea. If only isoacids and urea are included, the mixture smells like isoacids and does not reduce the deleterious effects of the isoacid odor. If only ammonium hydroxide is employed for the nitrogen source, there is a strong ammonium hydroxide smell that is overwhelming to humans. As noted above, the combination of urea and ammonium hydroxide provides the surprising benefit of masking the isoacid odor and reducing the overwhelming smell of ammonium hydroxide.

Thus, in a preferred embodiment, the urea and ammonium hydroxide are in a ratio of from about 90:10 to about 1:99 by weight urea to ammonium hydroxide in the nitrogen source; more preferably the urea and ammonium hydroxide are in a ratio of from about 85:15 to about 5:95 by weight urea to ammonium hydroxide in the nitrogen source; more preferably the urea and ammonium hydroxide are in a ratio of from about 80:20 to about 10:90 by weight urea to ammonium hydroxide in the nitrogen source; and most preferably the urea and ammonium hydroxide are in a ratio of from about 70:30 to about 15:85 by weight urea to ammonium hydroxide in the nitrogen source. Any ratio subsumed within the foregoing ratios is part of this express disclosure (including, for example, 2:98, 76:24, etc.).

Beneficially, this provides nitrogen and isoacids that both rumen and gut bacteria need while also controlling the isoacid odor before consumption. Both rumen and gut bacteria utilize the isoacids to make amino acids. A nitrogen source is needed for the bacteria to form amino acids from the isoacids as amino acids include nitrogen. Additionally, the nutritional feed supplements provide the additional benefit of being in a form that can be readily incorporated into both solid feeds and liquid feeds.

### Nutritionally Supplemented Animal Feed

Supplemented animal feeds can be prepared by combining the nutritional feed supplement with an animal feed. The animal feed can be a solid animal feed or liquid animal feed.

In a nutritionally supplemented solid feed, the nutritional supplement (combination of isoacids and nitrogen source) is preferably in an amount of from about 0.01 wt. % to about 55 wt. %, more preferably 0.1 wt. % to about 50 wt. %, most preferably about 1 wt. % to about 40 wt. %; and the solid animal feed is preferably in an amount of from about 45 wt. % to about 99.99 wt. %, more preferably 50 wt. % to about 99.9 wt. %, most preferably about 40 wt. % to about 99 wt. %; and the nutritionally supplemented solid animal feed can optionally comprise vitamins, minerals or other nutritional additives preferably in an amount of from about 0.01 wt. % to about 15 wt. %, more preferably from about 0.1 wt. % to about 10 wt. %.

In a nutritionally supplemented liquid feed, the nutritional supplement (combination of isoacids and nitrogen source) is preferably in an amount of from about 0.01 wt. % to about 75 wt. %, more preferably 0.1 wt. % to about 65 wt. %, most preferably about 1 wt. % to about 55 wt. %; and the liquid animal feed is preferably in an amount of from about 25 wt. % to about 99.99 wt. %, more preferably 35 wt. % to about 99.9 wt. %, most preferably about 45 wt. % to about 99 wt. %; and the nutritionally supplemented liquid feed can optionally comprise vitamins, minerals or other nutritional additives preferably in an amount of from about 0.01 wt. % to about 15 wt. %, more preferably from about 0.1 wt. % to about 10 wt. %.

A further embodiment comprises obtaining the nutritional feed supplement, combining the nutritional feed supplement with a solid animal feed in a feed mill to form a blended animal feed, which comprises the isoacid, and delivering the blended animal feed to the animals for consumption. Any suitable solid animal feeds can be combined with the nutritional feed supplement. Preferred solid animal feeds include, but are not limited to, grains, oilseeds, oilseed meals, forage byproducts, forages, oilseed byproducts animal-derived products (including, but not limited to, chicken, beef, fish), vegetables, nuts, seeds, fruits, tubers, or a mixture thereof.

In an embodiment, the nutritional feed supplement is combined with a liquid animal feed. The combination can be referred to as a supplemented liquid animal feed. As used herein, a liquid animal feed comprises any liquid animal feed as known in the art. For instance, a liquid animal feed may comprise various raw materials of agricultural, plant, animal, marine, or chemical origin and liquid additives such as molasses, glycerol, propylene glycol, solubles from fermentation (such as condensed distiller solubles), water, vegetable oils, animal fats, milk-whey products, sugars, protein concentrates, nutrients, fiber and the like. In an embodiment, the liquid comprises water. In an embodiment, the liquid is a liquid animal feed. In an embodiment, the liquid is water or another edible liquid.

In an embodiment, the supplemented liquid animal feed comprises from about 0.01 wt. % to about 75 wt. % of the nutritional feed supplement. In an embodiment, the supplemented liquid animal feed comprises from about 0.1 wt. % to about 65 wt. % of the nutritional feed supplement. In an embodiment, the supplemented liquid animal feed comprises from about 0.5 wt. % to about 50 wt. % of the nutritional feed supplement. In an embodiment, the supplemented liquid animal feed comprises from about 1 wt. % to about 35 wt. % of the nutritional feed supplement.

In an embodiment, the blended animal feed comprises from about 0.01 wt. % to about 55 wt. % of the nutritional feed supplement. In an embodiment, the blended animal feed comprises from about 0.1 wt. % to about 45 wt. % of the nutritional feed supplement. In an embodiment, the blended animal feed comprises from about 0.5 wt. % to about 35 wt. % of the nutritional feed supplement. In an embodiment, the supplemented liquid comprises from about 1 wt. % to about 30 wt. % of the nutritional feed supplement.

In an embodiment, the nutritional supplement can be provided directly to livestock and/or poultry without mixing with an animal feed. In this way it is provided as a nutritional supplement. In such an embodiment, the nutritional supplement can be provided without any additional ingredients or with other nutritional supplements such as vitamins, minerals, etc. In a further embodiment, it could be added to a liquid feed. Thus, in such an embodiment, the nutritional feed supplement can be provided to the livestock and/or poultry in an concentration of at least about 80%, at least about 85%, at least about 90%, at least about 95%, at least about 96%, at least about 97%, at least about 98%, at least about 99%, or at about 100%.

In a preferred embodiment, the animal is a ruminant, swine or poultry. In a preferred embodiment, the animal is a ruminant. As used herein, a ruminant refers to mammals that chew the cud regurgitated from its rumen. Ruminants comprise cattle, sheep, goats, water buffalo, antelopes, deer, giraffes, and their relatives.

In a preferred embodiment, the nutritionally supplemented animal feed comprises the nutritional feed supplement in an amount sufficient to increase milk production when fed to a ruminant.

In an embodiment, the blended animal feed comprises the nutritional feed supplement in an amount sufficient to increase milk production when fed to a ruminant.

In an embodiment, the supplemented liquid animal feed comprises the nutritional feed supplement in an amount sufficient to increase ADG in a livestock animal.

In an embodiment, the blended animal feed comprises the nutritional feed supplement in an amount sufficient to increase ADG in a livestock animal.

In an embodiment, the supplemented liquid comprises the nutritional feed supplement in an amount that provides an improved feed efficiency and feed conversion.

In an embodiment, the blended animal feed comprises the nutritional feed supplement in an amount that provides an improved feed efficiency and feed conversion.

### Odor Assessment

Odor can be assessed by any method known in the art. One such method includes the following protocol:

The Odor Assessor: a) must be free of colds or physical conditions that may affect the sense of smell; b) must not chew gum or eat at least 30 minutes prior to the test; c) must refrain from eating spicy foods prior to the test; and d) must not wear perfume cologne or after shave the day of the test.

During an odor test, the odor assessor sniffs test formulations in an opened container approximately six inches directly below the assessor's nostrils. They can then be qualitatively ranked on a scale of 1 to 5 with 1 being an unacceptable odor, 2 being sufficiently masked to reduce or eradicate the deleterious effects of the isoacid, 3 and 4 being good odors, and 5 being a pleasant odor.

### Feeding Livestock

Livestock can be provided the nutritional supplements as a liquid supplement. Additionally, the nutritional supplements can be added to liquid feed and/or solid feeds as described above. Accordingly, methods can be employed for providing the nutritional feed supplements directly to the animals via the nutritional supplements on their own or via a nutritionally supplemented feed. Such can comprise the step of feeding a livestock the nutritional supplement, or feeding a livestock a nutritionally supplemented animal feed; the animal feed can be a solid feed or a liquid feed.

### PREFERRED EMBODIMENTS

The present disclosure is further defined by the following numbered embodiments:
1. A nutritional feed supplement composition for livestock and poultry comprising: from about 30 wt. % to about 70 wt. % of one or more isoacids comprising isobutyric acid, butyric acid, 2-methylbutyric acid, 3-methylbutyric acid (isovaleric acid), valeric acid and salts thereof; and from about 30 wt. % to about 70 wt. % of a nitrogen source; wherein the nitrogen source comprises urea and ammonium hydroxide.
2. The nutritional feed supplement composition of embodiment 1, wherein the one or more isoacids are selected from the group consisting of isobutyric acid, butyric acid, 2-methylbutyric acid, 3-methylbutyric acid, valeric acid, salts thereof, and mixtures thereof.
3. The nutritional feed supplement composition of embodiment 1 or 2, wherein the urea and ammonium hydroxide are in a ratio of from about 90:10 to about 10:90 by weight urea to ammonium hydroxide.
4. The nutritional feed supplement composition of any one of embodiments 1-3, wherein the urea and ammonium hydroxide are in a ratio of from about 70:30 to about 15:85 by weight urea to ammonium hydroxide.
5. The nutritional feed supplement composition of any one of embodiments 1-4, wherein the nitrogen source is selected from the group consisting of urea and ammonium hydroxide.
6. The nutritional feed supplement composition of any one of embodiments 1-5, wherein the urea and ammonium hydroxide are in a ratio of about 50:50 by weight urea to ammonium hydroxide.
7. The nutritional feed supplement composition of any one of embodiments 1-6, wherein the one or more isoacids comprises from about 35 wt. % to about 65 wt. % of the composition, and wherein the nitrogen source comprises from about 35 wt. % to about 65 wt. % of the composition.
8. The nutritional feed supplement composition of any one of embodiments 1-7, wherein the one or more isoacids comprises from about 40 wt. % to about 60 wt. % of the composition, and wherein the nitrogen source comprises from about 40 wt. % to about 60 wt. % of the composition.
9. The nutritional feed supplement composition of any one of embodiments 1-8, wherein the composition comprises water sufficient to dissolve the urea and as added by an ammonium hydroxide solution.
10. The nutritional feed supplement composition of any one of embodiments 1-9, wherein the isobutyric acid, butyric acid, 2-methylbutyric acid, 3-methylbutyric acid (isovaleric acid), and valeric acid do not comprise additional pendant groups except for interactions with the ammonium hydroxide.
11. A nutritionally supplemented animal feed composition comprising: an animal feed comprising a grain, an oilseed, an oilseed meal, a forage byproduct, forages, an oilseed byproduct, an animal-derived product, a vegetable, a nut, a seed, a fruit, a tuber, molasses, a vegetable oil, a seed oil, an animal fat, a milk, whey, a polysaccharide, a protein concentrate, a vitamin, a mineral, a fiber, or a mixture thereof; and an isoacid nutritional supplement comprising a one or more isoacids comprising isobutyric acid, butyric acid, 2-methylbutyric acid, 3-methylbutyric acid (isovaleric acid), valeric acid, and salts thereof; a nitrogen source; wherein the nitrogen source comprises urea and ammonium hydroxide; wherein the isoacid nutritional supplement comprises from about 30 wt. % to about 70 wt. % of the one or more isoacids and from about 30 wt. % to about 70 wt. % of the nitrogen source.
12. The nutritionally supplemented animal feed composition of embodiment 11, wherein the one or more isoacids are selected from the group consisting of isobutyric acid, butyric acid, 2-methylbutyric acid, 3-methylbutyric acid, valeric acid, salts thereof, and mixtures thereof.
13. The nutritionally supplemented animal feed composition of embodiment 11 or 12, wherein the urea and ammonium hydroxide are in a ratio of from about 90:10 to about 10:90 by weight urea to ammonium hydroxide.
14. The nutritionally supplemented animal feed composition of any one of embodiments 11-13, wherein the urea and ammonium hydroxide are in a ratio of from about 70:30 to about 15:85 by weight urea to ammonium hydroxide.
15. The nutritionally supplemented animal feed composition of any one of embodiments 11-13, wherein the nitrogen source is selected from the group consisting of urea and ammonium hydroxide.
16. The nutritionally supplemented animal feed composition of any one of embodiments 11-15, wherein the urea and ammonium hydroxide are in a ratio of about 50:50 by weight urea to ammonium hydroxide.
17. The nutritionally supplemented animal feed composition of any one of embodiments 11-16, wherein the one or more isoacids comprises from about 35 wt. % to about 65 wt. % of the nutritional supplement, and wherein the nitrogen source comprises from about 35 wt. % to about 65 wt. % of the nutritional supplement.
18. The nutritionally supplemented animal feed composition of any one of embodiments 11-17, wherein the one or more isoacids comprises from about 40 wt. % to about 60 wt. % of the nutritional supplement, and wherein the nitrogen source comprises from about 40 wt. % to about 60 wt. % of the nutritional supplement.
19. The nutritionally supplemented animal feed composition of any one of embodiments 11-18, wherein the nutritional supplement comprises water sufficient to dissolve the urea.
20. The nutritionally supplemented animal feed composition of any one of embodiments 11-19, wherein the animal feed is a liquid animal feed and comprises molasses, a vegetable oil, a seed oil, an animal fat, a milk, glycerol, propylene glycol, solubles from fermentation (such as condensed distiller solubles), water, whey, a polysaccharide, a protein concentrate, a vitamin, a mineral, or a mixture thereof.
21. The nutritionally supplemented animal feed composition of embodiment 20, wherein the nutritional supplement (combination of isoacids and nitrogen source) is in an amount of from about 0.01 wt. % to about 75 wt. %; and wherein the liquid animal feed is in an amount of from about 25 wt. % to about 99.99 wt. %; and wherein the nutritionally supplemented animal feed optionally further comprises one or more vitamins, minerals or other nutritional additives in an amount of from about 0.01 wt. % to about 15 wt. %.
22. The nutritionally supplemented animal feed composition of any one of embodiments 11-19, wherein the animal feed is a solid animal feed and comprises a grain, an oilseed, an oilseed meal, a forage byproduct, forages, an oilseed byproduct, an animal-derived product, a vegetable, a nut, a seed, a fruit, a tuber, an animal fat, whey, a polysaccharide, a protein concentrate, a vitamin, a mineral, a fiber, or a mixture thereof.
23. The nutritionally supplemented animal feed composition of embodiment 22, wherein the nutritional supplement (combination of isoacids and nitrogen source) is in an amount of from about 0.01 wt. % to about 55 wt. %; and wherein the solid animal feed is in an amount of from about 45 wt. % to about 99.99 wt. %; and wherein the nutritionally supplemented animal feed optionally further comprises one or more vitamins, minerals or other nutritional additives in an amount of from about 0.01 wt. % to about 15 wt. %.
24. The nutritionally supplemented animal feed composition of embodiment 22 or 23, wherein the animal feed comprises a blended solid animal feed and/or a TMR.
25. The nutritionally supplemented animal feed composition of any one of embodiments 11-24, wherein the isobutyric acid, butyric acid, 2-methylbutyric acid, 3-methylbutyric acid (isovaleric acid), do not comprise additional pendant groups except for interactions with the ammonium hydroxide.
26. A method of preparing a nutritional feed supplement composition having an acceptable odor for a human handler comprising: combining from about 30 wt. % to about 70 wt. % of one or more isoacids comprising isobutyric acid, butyric acid, 2-methylbutyric acid, 3-methylbutyric acid (isovaleric acid), valeric acid, and salts thereof; and from about 30 wt. % to about 70 wt. % of a nitrogen source; wherein the nitrogen source comprises urea and ammonium hydroxide.
27. The method of embodiment 26, wherein the combining comprises mixing with a paddle mixer.
28. The method of embodiment 26 or 27, wherein the one or more isoacids are selected from the group consisting of isobutyric acid, butyric acid, 2-methylbutyric acid, 3-methylbutyric acid, valeric acid, salts thereof, and mixtures thereof.
29. The method of any one of embodiments 26-28, wherein the urea and ammonium hydroxide are in a ratio of from about 90:10 to about 10:90 by weight urea to ammonium hydroxide.
30. The method of any one of embodiments 26-29, wherein the urea and ammonium hydroxide are in a ratio of from about 70:30 to about 15:85 by weight urea to ammonium hydroxide.
31. The method of any one of embodiments 26-30, wherein the nitrogen source is selected from the group consisting of urea and ammonium hydroxide.
32. The method of any one of embodiments 26-31, wherein the urea and ammonium hydroxide are in a ratio of about 50:50 by weight urea to ammonium hydroxide.
33. The method of any one of embodiments 26-32, wherein the one or more isoacids comprises from about 35 wt. % to about 65 wt. % of the composition, and wherein the nitrogen source comprises from about 35 wt. % to about 65 wt. % of the composition.
34. The method of any one of embodiments 26-33, wherein the one or more isoacids comprises from about 40 wt. % to about 60 wt. % of the composition, and wherein the nitrogen source comprises from about 40 wt. % to about 60 wt. % of the composition.
35. The method of any one of embodiments 26-34, wherein the composition comprises water sufficient to dissolve the urea.
36. The method of any one of embodiments 26-35, wherein the isobutyric acid, butyric acid, 2-methylbutyric acid, 3-methylbutyric acid (isovaleric acid), and valeric acid do not comprise additional pendant groups.
37. A method of preparing a nutritionally supplemented animal feed composition having an acceptable odor for a human handler comprising: combining an animal feed and an isoacid nutritional supplement to form the nutritionally supplemented animal feed composition; wherein the animal feed comprises a grain, an oilseed, an oilseed meal, a forage byproduct, forages, an oilseed byproduct, an animal-derived product, a vegetable, a nut, a seed, a fruit, a tuber, molasses, a vegetable oil, a seed oil, an animal fat, a milk, glycerol, propylene glycol, solubles from fermentation (such as condensed distiller solubles), water, whey, a polysaccharide, a protein concentrate, a vitamin, a mineral, a fiber, or a mixture thereof; wherein an isoacid nutritional supplement comprising one or more isoacids comprising isobutyric acid, butyric acid, 2-methylbutyric acid, 3-methylbutyric acid (isovaleric acid), valeric acid, and salts thereof; a nitrogen source; wherein the nitrogen source comprises urea and ammonium hydroxide; and wherein the isoacid nutritional supplement comprises from about 30 wt. % to about 70 wt. % of the mixture of two or more isoacids and from about 30 wt. % to about 70 wt. % of the nitrogen source.
38. The method of embodiment 37, wherein the one or more isoacids are selected from the group consisting of isobutyric acid, butyric acid, 2-methylbutyric acid, 3-methylbutyric acid, valeric acid, salts thereof, and mixtures thereof.
39. The method of embodiment 37 or 38, wherein the urea and ammonium hydroxide are in a ratio of from about 90:10 to about 10:90 by weight urea to ammonium hydroxide.
40. The method of any one of embodiments 37-39, wherein the urea and ammonium hydroxide are in a ratio of from about 70:30 to about 15:85 by weight urea to ammonium hydroxide.
41. The method of any one of embodiments 37-40, wherein the nitrogen source is selected from the group consisting of urea and ammonium hydroxide.
42. The method of any one of embodiments 37-41, wherein the urea and ammonium hydroxide are in a ratio of about 50:50 by weight urea to ammonium hydroxide.
43. The method of any one of embodiments 37-42, wherein the one or more isoacids comprises from about 35 wt. % to about 65 wt. % of the nutritional supplement, and wherein the nitrogen source comprises from about 35 wt. % to about 65 wt. % of the nutritional supplement.
44. The method of any one of embodiments 37-43, wherein the one or more isoacids comprises from about 40 wt. % to about 60 wt. % of the nutritional supplement, and wherein the nitrogen source comprises from about 40 wt. % to about 60 wt. % of the nutritional supplement.
45. The method of any one of embodiments 37-44, wherein the isoacid nutritional supplement comprises water sufficient to dissolve the urea.
46. The method of any one of embodiments 37-45, wherein the animal feed is a liquid animal feed and comprises molasses, a vegetable oil, a seed oil, an animal fat, a milk, glycerol, propylene glycol, solubles from fermentation (such as condensed distiller solubles), water, whey, a polysaccharide, a protein concentrate, a vitamin, a mineral, or a mixture thereof.
47. The method of embodiment 46, wherein the nutritional supplement (combination of isoacids and nitrogen source) is in an amount of from about 0.01 wt. % to about 75 wt. %; and wherein the liquid animal feed is in an amount of from about 25 wt. % to about 99.99 wt. %; and wherein the nutritionally supplemented animal feed optionally further comprises one or more vitamins, minerals or other nutritional additives in an amount of from about 0.01 wt. % to about 15 wt. %.
48. The method of any one of embodiments 37-45, wherein the animal feed is a solid animal feed and comprises a grain, an oilseed, an oilseed meal, a forage byproduct, forages, an oilseed byproduct, an animal-derived product, a vegetable, a nut, a seed, a fruit, a tuber, an animal fat, whey, a polysaccharide, a protein concentrate, a vitamin, a mineral, a fiber, or a mixture thereof.
49. The method of embodiment 48, wherein the nutritional supplement (combination of isoacids and nitrogen source) is in an amount of from about 0.01 wt. % to about 55 wt. %; and wherein the solid animal feed is in an amount of from about 45 wt. % to about 99.99 wt. %; and wherein the nutritionally supplemented animal feed optionally further comprises one or more vitamins, minerals or other nutritional additives in an amount of from about 0.01 wt. % to about 15 wt. %.
50. The method of embodiment 48 or 49, wherein the animal feed comprises a blended solid animal feed and/or a TMR.
51. The method of any one of embodiments 37-50, wherein the isobutyric acid, butyric acid, 2-methylbutyric acid, 3-methylbutyric acid (isovaleric acid), and valeric acid do not comprise additional pendant groups.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following commercially available materials were utilized in the Examples: aqueous ammonium hydroxide solution (as the source of the ammonia group) and urea.

The nutritional supplements as disclosed herein were assessed for odor. The ratios of isoacid to nitrogen source were varied and the ratio of nitrogen sources was varied for evaluation. Controls included isoacids alone, isoacids mixed with urea, and isoacids mixed with ammonium hydroxide. The test protocol and specific ratios are summarized below.

Odor was evaluated according to the following procedures. The results are provided in the below tables and accompanying figures. The Odor Assessors: a) must be free of colds or physical conditions that may affect the sense of smell; b) must not chew gum or eat at least 30 minutes prior to the test; c) must refrain from eating spicy foods prior to the test; and d) must not wear perfume cologne or after shave the day of the test. During an odor test, the odor assessors sniff test formulations in an opened container approximately six inches directly below the assessor's nostrils.

Odor Assessment with Isobutyric Acid

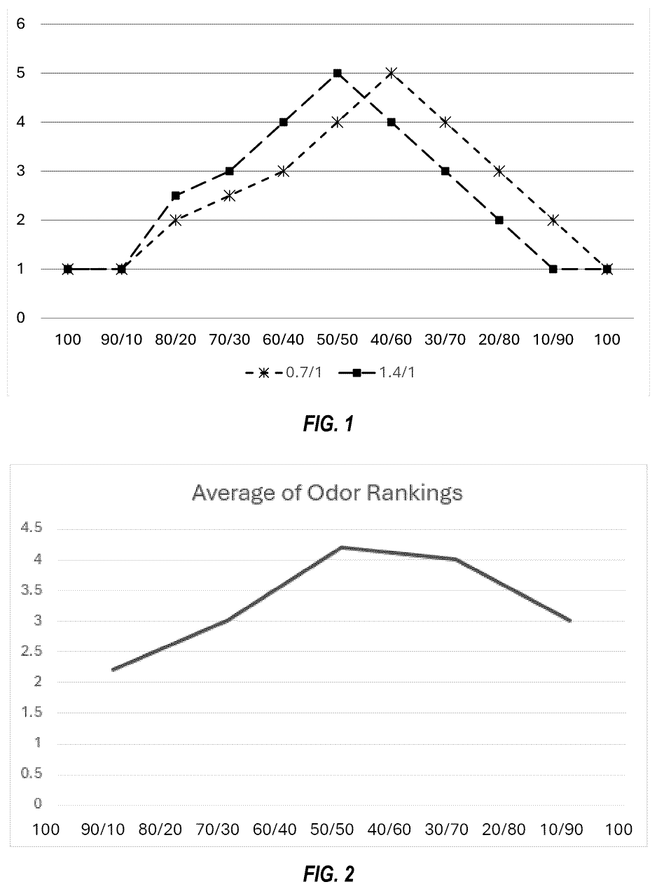

The test formulations were a mixture of the nitrogen source with isobutyric acid (as an example isoacid) at two different molar ratios (0.7 nitrogen: 1 isoacid, and 1.4 nitrogen to 1 isoacid). Nitrogen sources were prepared with 100 wt. % urea, 90 wt. % urea and 10 wt. % ammonium hydroxide, 80 wt. % urea and 20 wt. % ammonium hydroxide, 70 wt. % urea and 30 wt. % ammonium hydroxide, 60 wt. % urea and 40 wt. % ammonium hydroxide, 50 wt. % urea and 50 wt. % ammonium hydroxide, 40 wt. % urea and 60 wt. % ammonium hydroxide, 30 wt. % urea and 70 wt. % ammonium hydroxide, 20 wt. % urea and 80 wt. % ammonium hydroxide, 10 wt. % urea and 90 wt. % ammonium hydroxide, and 100 wt. % ammonium hydroxide. The odor was ranked on a scale of 1 to 5 with 1 being an unacceptable odor (due to strong isoacid smell or strong ammonia smell) and 5 being a good odor. The odor intensity is then qualitatively compared to control samples: isobutyric acid (IBA) and ammonia. The test is repeated as necessary with the assessor revisiting the controls and test product as often as necessary prior to a qualitative confidence being reached. The assessor then repeats this test on a series of no greater than ten individual test products in one 24-hour period. The individual estimated intensities for three to five assessments and are averaged to the nearest whole number to determine the reportable odor intensity. The collected ratings are provided in the Table 1 below and reflected in a graph at FIG. 1.

TABLE 1

Nitrogen to Isoacid
(Molar Ratio)

| | | |
|---|---|---|
| Weight Ratio of Urea | 0.7:1 | 1.4:1 |

| | |
|---|---|
| to Ammonium Hydroxide | Odor Rating |

| | | |
|---|---|---|
| 100:0 | 1 | 1 |
| 90:10 | 1 | 1 |
| 80:20 | 2.5 | 2 |
| 70:30 | 3 | 2.5 |
| 60:40 | 4 | 3 |
| 50:50 | 5 | 4 |
| 40:60 | 4 | 5 |
| 30:70 | 3 | 4 |
| 20:80 | 2 | 3 |
| 10:90 | 1 | 2 |
| 0:100 | 1 | 1 |

As can be seen from the data in the Table 1 and FIG. 1, when the isoacid was combined with only urea or only ammonium hydroxide, the odor was still highly problematic as the ammonia smell was considered overwhelming and the urea-only did not mask the odor of the isoacid. At a ranking of 2, the assessors did not experience the deleterious effects of the isoacid. Odors ranked at 3 and 4 were considered preferred over 2 and more pleasant and odor 5 was considered a good odor.

Odor Assessment with Mixtures of Isoacids

The same procedures were followed for odor assessment. Multiple odor assessors were employed and the qualitative odor scores were averaged. The same scale was used. In this testing, no 100% urea or 100% ammonium hydroxide were tested given that neither provided an acceptable odor in the first phase of testing. In addition to isobutyric acid (IBA), butyric acid (BA), 2-methylbutyric acid (2MBA), and 3-methylbutyric acid (3MBA) were also included and tested. Again, the test formulations were a mixture of the nitrogen source with isoacids at two different weight ratios; however, the ratios were modified from the first test (0.7:1 and 1.4:1, nitrogen to isoacid). The makeup of isoacid mixtures and nitrogen sources, and the ratios of isoacid to nitrogen sources are provided along with the averaged ratings in Table 2 below and in FIG. 2.

TABLE 2

| | | Weight Ratio of Urea to Ammonium Hydroxide | | | | |
|---|---|---|---|---|---|---|
| | Molar Ratio of | 90:10 | 70:30 | 50:50 | 30:70 | 10:90 |
| Isoacid | Nitrogen to Isoacid | Odor Rating | | | | |
| IBA | 0.7:1 | 2 | 3 | 4 | 4 | 5 |
| IBA | 1.4:1 | 1 | 2 | 4 | 5 | 3 |
| 2MBA | 0.7:1 | 1 | 2 | 3 | 4 | 5 |
| 2MBA | 1.4:1 | 1 | 2 | 5 | 4 | 2 |
| IBA & 2MBA | 0.7:1 | 1 | 2 | 3 | 4 | 5 |
| (80:20) | | | | | | |
| IBA & BA | 1.4:1 | 1 | 2 | 4 | 5 | 3 |
| (80/20) | | | | | | |

As can be seen from the data in Table 2 and accompanying FIG. 2, in this instance the increased amount of nitrogen (1.4:1) continued to suffer odor problems even at the 90:10 weight ratio of urea to ammonium hydroxide. Further the 90:10 ratio had odor issues with the 2MBA and mixed isoacids. However, at the 70:30 ratio the odors were acceptable for all test formulations. Again, at a ranking of 2, the assessors did not experience the deleterious effects of the isoacid. Odors ranked at 3 and 4 were considered preferred over 2 and more pleasant and odor 5 was considered a good odor.

Accordingly, it was found that while neither ammonium hydroxide nor urea on their own control or improve the odor of the isoacids; mixtures of the two along can mask the deleterious odors of the isoacids. This is beneficial as the nutritional supplements can be in the presence of humans including individuals responsible for preparation of the nutritional supplements, individuals responsible for the preparation of supplemented animal feed, individuals responsible for transportation of the supplements and/or supplemented foods, and individuals feeding and otherwise caretaking the livestock. Beneficially, the nutritional supplements and/or nutritionally supplemented animal feeds can be left in the open without concern for deleterious effects on humans in the vicinity. Further, there is no need for reactive chemistry previously used and required to control odor (such as the reaction of isoacids to intentionally attach pendant groups).

The above disclosure is intended to be illustrative and not exhaustive. This description will suggest many variations and alternatives to one of ordinary skill in this art. All these alternatives and variations are intended to be included within the scope of the following claims where the term “comprising” means “including, but not limited to”. Those familiar with the art may recognize other equivalents to the specific embodiments described herein which equivalents are also intended to be encompassed by the following claims.

What is claimed is:

1. A nutritional feed supplement composition for livestock and poultry comprising:
from about 30 wt. % to about 70 wt. % of one or more isoacids comprising isobutyric acid, butyric acid, 2-methylbutyric acid, 3-methylbutyric acid, valeric acid and salts thereof; and
from about 30 wt. % to about 70 wt. % of a nitrogen source; wherein the nitrogen source comprises urea and ammonium hydroxide.

2. The nutritional feed supplement composition of claim 1, wherein the one or more isoacids are selected from the group consisting of isobutyric acid, butyric acid, 2-methylbutyric acid, 3-methylbutyric acid, valeric acid, salts thereof, and mixtures thereof.

3. The nutritional feed supplement composition of claim 1, wherein the urea and ammonium hydroxide are in a ratio of from about 90:10 to about 10:90 by weight urea to ammonium hydroxide.

4. The nutritional feed supplement composition of claim 3, wherein the nitrogen source is selected from the group consisting of urea and ammonium hydroxide.

5. The nutritional feed supplement composition of claim 4, wherein the urea and ammonium hydroxide are in a ratio of about 50:50 by weight urea to ammonium hydroxide.

6. The nutritional feed supplement composition of claim 1, wherein the one or more isoacids comprises from about 35 wt. % to about 65 wt. % of the composition, and wherein the nitrogen source comprises from about 35 wt. % to about 65 wt. % of the composition.

7. The nutritional feed supplement composition of claim 1, wherein the composition comprises water sufficient to dissolve the urea and as added by an ammonium hydroxide solution.

8. The nutritional feed supplement composition of claim 1, wherein the isobutyric acid, butyric acid, 2-methylbutyric acid, 3-methylbutyric acid, and valeric acid do not comprise additional pendant groups except for interactions with the ammonium hydroxide.

9. A nutritionally supplemented animal feed composition comprising:
an animal feed comprising a grain, an oilseed, an oilseed meal, a forage byproduct, forages, an oilseed byproduct, an animal-derived product, a vegetable, a nut, a seed, a fruit, a tuber, molasses, a vegetable oil, a seed oil, an animal fat, a milk, whey, a polysaccharide, a protein concentrate, a vitamin, a mineral, a fiber, or a mixture thereof; and
an isoacid nutritional supplement comprising a one or more isoacids comprising isobutyric acid, butyric acid, 2-methylbutyric acid, 3-methylbutyric acid, valeric acid, and salts thereof; a nitrogen source; wherein the nitrogen source comprises urea and ammonium hydroxide;
wherein the isoacid nutritional supplement comprises from about 30 wt. % to about 70 wt. % of the one or more isoacids and from about 30 wt. % to about 70 wt. % of the nitrogen source.

10. The nutritionally supplemented animal feed composition of claim 9, wherein the one or more isoacids are selected from the group consisting of isobutyric acid, butyric acid, 2-methylbutyric acid, 3-methylbutyric acid, valeric acid, salts thereof, and mixtures thereof; and wherein the urea and ammonium hydroxide are in a ratio of from about 90:10 to about 10:90 by weight urea to ammonium hydroxide.

11. The nutritionally supplemented animal feed composition of claim 9, wherein the animal feed is a liquid animal feed and comprises molasses, a vegetable oil, a seed oil, an animal fat, a milk, glycerol, propylene glycol, solubles from fermentation, water, whey, a polysaccharide, a protein concentrate, a vitamin, a mineral, or a mixture thereof.

12. The nutritionally supplemented animal feed composition of claim 9, wherein the animal feed is a solid animal feed and comprises a grain, an oilseed, an oilseed meal, a forage byproduct, forages, an oilseed byproduct, an animal-derived product, a vegetable, a nut, a seed, a fruit, a tuber, an animal fat, whey, a polysaccharide, a protein concentrate, a vitamin, a mineral, a fiber, or a mixture thereof.

13. The nutritionally supplemented animal feed composition of claim 12, wherein the animal feed comprises a blended solid animal feed and/or a TMR.

14. The nutritionally supplemented animal feed composition of claim 9, wherein the isobutyric acid, butyric acid, 2-methylbutyric acid, 3-methylbutyric acid, do not comprise additional pendant groups except for interactions with the ammonium hydroxide.

15. A method of preparing a nutritional feed supplement composition having an acceptable odor for a human handler comprising:
combining from about 30 wt. % to about 70 wt. % of one or more isoacids comprising isobutyric acid, butyric acid, 2-methylbutyric acid, 3-methylbutyric acid, valeric acid, and salts thereof;
and from about 30 wt. % to about 70 wt. % of a nitrogen source; wherein the nitrogen source comprises urea and ammonium hydroxide.

16. The method of claim 15, wherein the combining comprises mixing with a paddle mixer.

17. The method of claim 15, wherein the one or more isoacids are selected from the group consisting of isobutyric acid, butyric acid, 2-methylbutyric acid, 3-methylbutyric acid, valeric acid, salts thereof, and mixtures thereof; and wherein the urea and ammonium hydroxide are in a ratio of from about 90:10 to about 10:90 by weight urea to ammonium hydroxide.

18. The method of claim 17, wherein the one or more isoacids comprises from about 35 wt. % to about 65 wt. % of the composition, and wherein the nitrogen source comprises from about 35 wt. % to about 65 wt. % of the composition.

19. The method of claim 18, wherein the composition comprises water sufficient to dissolve the urea.

20. The method of claim 15, further comprising
combining an animal feed and the isoacid nutritional supplement to form a nutritionally supplemented animal feed composition;
wherein the animal feed comprises a grain, an oilseed, an oilseed meal, a forage byproduct, forages, an oilseed byproduct, an animal-derived product, a vegetable, a nut, a seed, a fruit, a tuber, molasses, a vegetable oil, a seed oil, an animal fat, a milk, whey, a polysaccharide, a protein concentrate, a vitamin, a mineral, a fiber, or a mixture thereof;
wherein an isoacid nutritional supplement comprising one or more isoacids comprising isobutyric acid, butyric acid, 2-methylbutyric acid, 3-methylbutyric acid, valeric acid, and salts thereof; a nitrogen source; wherein the nitrogen source comprises urea and ammonium hydroxide; and
wherein the isoacid nutritional supplement comprises from about 30 wt. % to about 70 wt. % of the mixture of two or more isoacids and from about 30 wt. % to about 70 wt. % of the nitrogen source.
